(19) United States
(12) Patent Application Publication
(10) Pub. No.: US 2026/0124987 A1
(43) Pub. Date: May 7, 2026

(54) TRAILER-OPERATED WARNING SYSTEMS AND METHODS

(71) Applicant: Andrew McIsaac, Edmonton (CA)

(72) Inventor: Andrew McIsaac, Edmonton (CA)

(21) Appl. No.: 19/381,583

(22) Filed: Nov. 6, 2025

Related U.S. Application Data
(60) Provisional application No. 63/833,212, filed on Nov. 6, 2024.

(51) Int. Cl. B60Q 1/50; B60Q 1/00; B60R 16/033; F21V 23/04

(52) U.S. Cl. CPC B60Q 1/543; B60Q 1/0094; B60R 16/033; F21V 23/0407

(57) ABSTRACT

Systems and methods are discussed for operating emergency flashing lights on a trailer that is parked on a roadway to alert passing motorists, where the trailer is not connected to a tow vehicle. The systems operate on power provided by batteries installed on the trailer.

### CROSS-REFERENCE TO RELATED APPLICATIONS

This application claims priority of U.S. provisional patent application Ser. No. 63/833,212 filed Nov. 6, 2024, which is incorporated by reference into this application in its entirety.

### TECHNICAL FIELD

The present disclosure is related to the field of warning systems for trailers, in particular, warning systems for trailers having a source of power thereon for emergency flashing the running lights and signal lights disposed on the trailer.

### BACKGROUND

In some circumstances, trailers used for hauling freight, equipment, and the like may need to be left alongside a roadway due to a mechanical failure in the trailer itself or in the tow vehicle for the trailer. In such circumstances, it can be desirable to flash the direction signal lights and running lights on the trailer as a warning mechanism to alert passing motorists to the trailer parked alongside the roadway so as to avoid the motorists colliding with the trailer, especially during nighttime. For the purposes of this specification, and the claims that follow, the term “trailer” is defined to include all forms of trailers known to those skilled in the art, from large commercial-use trailers used for hauling freight, equipment, and the like to recreational-use trailers, tent trailers, camping trailers, enclosed cargo trailers, horse trailers, livestock trailers, “toy-haulers”, and utility trailers.

Tow vehicles are typically connected to trailers using an electrical cable system wherein the tow vehicle can control the operation of the direction signal lights, reverse lights, brake lights, and running lights on the trailer.

Referring to FIG. 1, a prior art direction signal light flashing system A using a three-terminal flasher device B that can be disposed on tow vehicles is shown.

Referring to FIG. 2, a prior art 7-way electrical cable system used between tow vehicles and trailers, as well known to those skilled in the art, is shown with 7-way vehicle wiring connector C and 7-way trailer wiring connector D, wherein the 7-way electrical cable system can allow the tow vehicle to operate the direction signal lights, reverse lights, brake lights, and running lights disposed on the trailer.

Referring to FIG. 3, a prior art 7-way trailer wiring connector C typically disposed on tow vehicles is shown.

Referring to FIG. 4, a prior art 3-terminal flasher relay device B is shown having potentiometer P disposed thereon that set the frequency in which the device operates at.

Referring to FIG. 5, a prior art coupler E used for polyethylene pipe is shown.

If a disabled trailer can remain connected to its tow vehicle via the 7-way electrical cable system, then the lights on the trailer can be flashed using the flasher circuit disposed on the tow vehicle. However, if the tow vehicle is not present, and the trailer is left by itself on the side of roadway, there is no way to flash the lights disposed on the trailer to alert passing motorists of its presence.

It is, therefore, desirable to provide a trailer-operated warning systems and methods for trailers not connected to a tow vehicle to alert the presence of the trailer to passing motorists.

### SUMMARY

Systems and methods directed to a trailer-operated warning system (“TOWS”) are provided. In some embodiments, the TOWS can utilize a trailer's battery with a timing relay to operate, namely, to flash the trailer's exterior lights. In some embodiments, the systems and methods can enable the trailer to have its lights comprising direction signal lights and running lights disposed thereon without a tow vehicle connected to the trailer. In some embodiments, the purpose of this is to illuminate the lights of the trailer when it has to be disconnected from the tow vehicle and left by itself on the side of a roadway. In some embodiments, this warning system can provide a visual indicator to approaching vehicles to see the parked trailer in advance and avoid any accidental collision with the trailer.

Broadly stated, in some embodiments, a warning system for a trailer can be provided, the trailer comprising a direct current (“DC”) battery disposed thereon, the trailer further comprising a trailer wiring connector disposed thereon, the trailer wiring connector operatively coupled to electrical lights disposed on the trailer, the system comprising: a flasher mechanism operatively coupled to the DC battery and to the electrical lights via the trailer wiring connector, the flasher mechanism configured to flash the electrical lights on and off when operatively coupled to the DC battery; and the flasher mechanism configured for adjusting a frequency of flashing the electrical lights on and off at a predetermined rate.

Broadly stated, in some embodiments, the flasher mechanism can comprise a three-terminal solid state flasher relay device.

Broadly stated, in some embodiments, the flasher relay can comprise a first potentiometer configured for adjusting the frequency of flashing the electrical lights on and off.

Broadly stated, in some embodiments, the flasher relay can comprise a second potentiometer configured for adjusting a duty cycle of flashing the electrical lights on and off.

Broadly stated, in some embodiments, the flasher mechanism can be disposed in a vehicle wiring connector, the vehicle wiring connector configured for operatively coupling the flasher mechanism to the DC battery and to the electrical lights when the vehicle wiring connector is operatively connected to the trailer wiring connector, whereupon inserting the vehicle wiring connector into the trailer wiring connector results in the flasher mechanism flashing the electrical lights disposed on the trailer on and off.

Broadly stated, in some embodiments, the flasher mechanism can comprise a microcontroller circuit comprising a microcontroller configured for carrying out a series of machine-readable instructions stored in a memory thereon.

Broadly stated, in some embodiments, the microcontroller circuit can comprise a first potentiometer operatively coupled to the microcontroller, the combination of the first potentiometer and the microcontroller configured for adjusting the frequency of flashing the electrical lights on and off.

Broadly stated, in some embodiments, a second potentiometer can be operatively coupled to the microcontroller, the combination of the second potentiometer and the microcontroller configured for adjusting a duty cycle of flashing the electrical lights on and off.

Broadly stated, in some embodiments, the electrical lights can comprise one or more of left signal lights, right signal lights, brake lights, reverse lights, and running lights.

Broadly stated, in some embodiments, the warning system can comprise a switch configured for enabling or disabling flashing of the running lights on and off.

Broadly stated, in some embodiments, an improved trailer can be provided, the trailer comprising a direct current (“DC”) battery disposed thereon, the trailer further comprising a trailer wiring connector disposed thereon, the trailer wiring connector operatively coupled to electrical lights disposed on the trailer, the improvement comprising a warning system for the trailer, the improvement comprising: a flasher mechanism operatively coupled to the DC battery and to the electrical lights via the trailer wiring connector, the flasher mechanism configured to flash the electrical lights on and off when operatively coupled to the DC battery; and the flasher mechanism configured for adjusting a frequency of flashing the electrical lights on and off at a predetermined rate.

Broadly stated, in some embodiments, a method can be provided for flashing electrical lights disposed on a trailer, the trailer comprising a direct current (“DC”) battery disposed thereon, the trailer further comprising a trailer wiring connector disposed thereon, the trailer wiring connector operatively coupled to the electrical lights disposed on the trailer, the method comprising the steps of: flashing the electrical lights on and off with a flasher mechanism, the flasher mechanism operatively coupled to the DC battery and to the electrical lights via the trailer wiring connector, the flasher mechanism configured to flash the electrical lights on and off when operatively coupled to the DC battery; and adjusting a frequency of the flashing the electrical lights on and off at a predetermined rate.

Broadly stated, in some embodiments, the method can comprise adjusting a duty cycle of the flashing the electrical lights on and off.

### BRIEF DESCRIPTION OF THE DRAWINGS

FIG. 1 is a block diagram depicting a prior art light flasher circuit disposed on motor vehicles.

FIG. 2 is a block diagram depicting a prior art 7-way electrical cable system for electrically connecting tow vehicles to trailers to control the direction signal lights, reverse lights, brake lights, and running lights disposed on the trailers.

FIG. 3 is a photograph depicting a prior art 7-way electrical connector disposed on tow vehicles.

FIG. 4 is a photograph depicting a prior art three-terminal flasher relay device used in vehicle flasher circuits, the relay device having a potentiometer control for adjust the flashing frequency of the device.

FIG. 5 is a photograph depicting a prior art polyethylene pipe coupler that can be adapted to making one embodiment of the systems described herein.

FIG. 6 is a block diagram depicting a first embodiment of a system for controlling the flashing of lights disposed on a trailer.

FIG. 7 is a block diagram depicting a second embodiment of a system for controlling the flashing of lights disposed on a trailer.

FIG. 8 is a photograph depicting an example of a physical implementation of the system of FIG. 6 prior to final assembly.

FIG. 9 is a photograph depicting the system of FIG. 8 after assembly.

FIG. 10 is a block diagram depicting a third embodiment of a system for controlling the flashing of lights disposed on a trailer.

FIG. 11 is a block diagram depicting a fourth embodiment of a system for controlling the flashing of lights disposed on a trailer.

FIG. 12 a block diagram depicting a fifth embodiment of a system for controlling the flashing of lights disposed on a trailer, the system comprising a microcontroller for controlling the flashing.

FIG. 13 is an electrical schematic depicting one embodiment of the microcontroller of FIG. 12.

FIG. 14 is a block diagram depicting a sixth embodiment of a system for controlling the flashing of lights disposed on a trailer, the system comprising a microcontroller for controlling the flashing.

FIG. 15 is an electrical schematic depicting one embodiment of the microcontroller of FIG. 14.

FIG. 16 is a block diagram depicting a flowchart of steps carried out by the microcontroller of FIG. 12 or FIG. 14.

FIG. 17 is an X-Y plot depicting a waveform of electrical power applied to lights disposed on a trailer using the microcontroller of FIG. 12 or FIG. 14.

FIG. 18 is a photograph depicting a trailer parked alongside a way without having a trailer-operated warning system.

FIG. 19 is a photograph depicting a trailer parked alongside a way having a trailer-operated warning system disposed thereon.

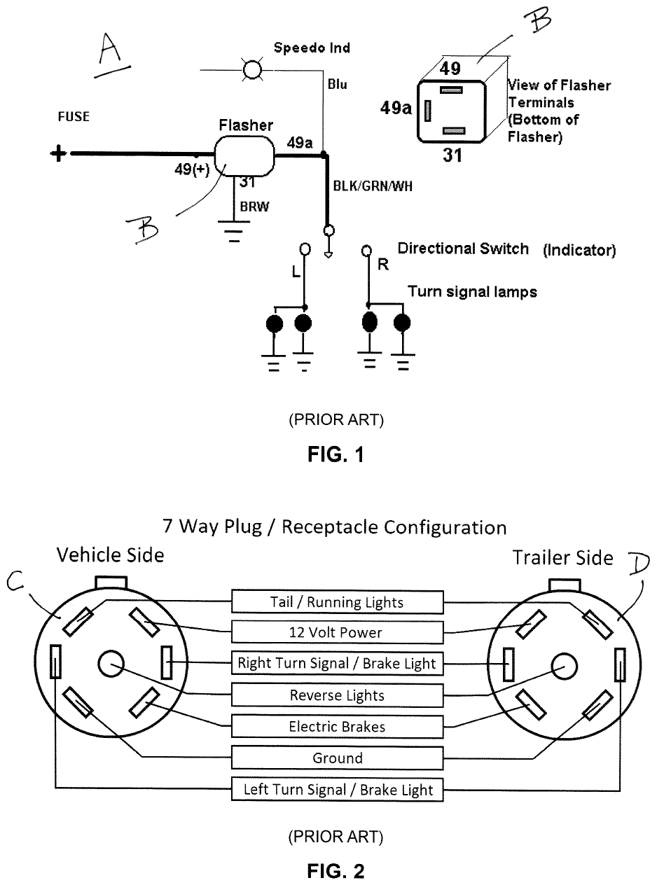

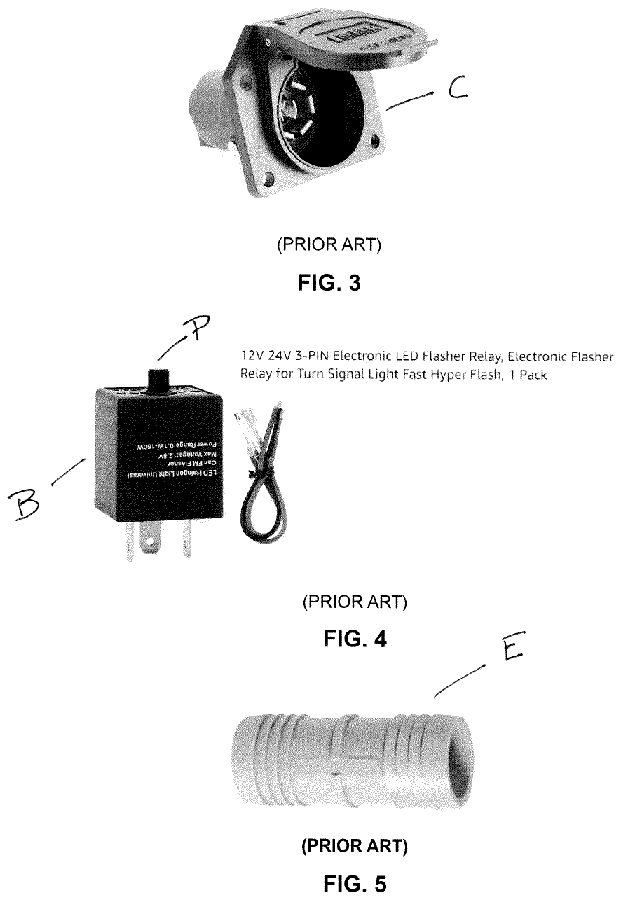

### DETAILED DESCRIPTION OF EMBODIMENTS

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment can also be included in other embodiments but is not necessarily included. Thus, the present technology can include a variety of combinations and/or integrations of the embodiments described herein.

The presently disclosed subject matter is illustrated by specific but non-limiting examples throughout this description. The examples may include compilations of data that are representative of data gathered at various times during the course of development and experimentation related to the present invention(s). Each example is provided by way of explanation of the present disclosure and is not a limitation thereon. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

All references to singular characteristics or limitations of the present disclosure shall include the corresponding plural characteristic(s) or limitation(s) and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

While the following terms used herein are believed to be well understood by one of ordinary skill in the art, definitions are set forth to facilitate explanation of the presently disclosed subject matter.

Unless defined otherwise, all technical and scientific terms used herein have the same meaning as commonly understood by one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in this application, including the claims.

Unless otherwise indicated, all numbers expressing quantities, properties, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently disclosed subject matter.

As used herein, the term “about”, when referring to a value or to an amount of mass, weight, time, volume, concentration or percentage is meant to encompass variations of in some embodiments+/−50%, in some embodiments+/−40%, in some embodiments+/−30%, in some embodiments+/−20%, in some embodiments+/−10%, in some embodiments+/−5%, in some embodiments+/−1%, in some embodiments+/−0.5%, and in some embodiments+/−0.1% from the specified amount, as such variations are appropriate to perform the disclosed method.

Alternatively, the terms “about” or “approximately” can mean within an acceptable error range for the particular value as determined by one of ordinary skill in the art, which will depend in part on how the value is measured or determined, i.e., the limitations of the measurement system. For example, “about” can mean within 3, or more than 3, standard deviations, per the practice in the art. Alternatively, “about” can mean a range of up to 20%, preferably up to 10%, more preferably up to 5%, and more preferably still up to 1% of a given value. Alternatively, particularly with respect to biological systems or processes, the term can mean within an order of magnitude, preferably within 5-fold, and more preferably within 2-fold, of a value. Unless otherwise indicated, all numbers expressing quantities, properties, and so forth used in the specification and claims are to be understood as being modified in all instances by the term “about”. And so, the numerical parameters set forth in this specification and claims are approximations that can vary depending upon the desired properties sought to be obtained by the presently disclosed subject matter.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

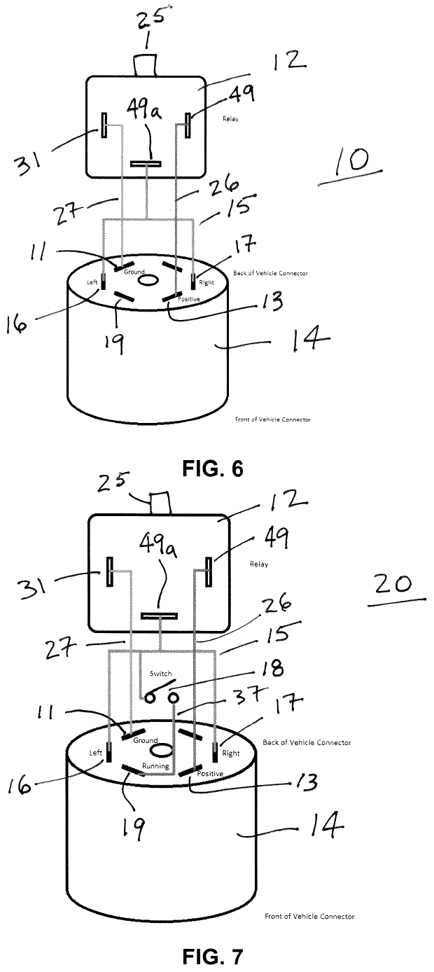

Referring to FIG. 6, one embodiment of trailer-operated warning system (“TOWS”) 10 is shown. In some embodiments, TOWS 10 can comprise of 7-way vehicle wiring connector 14 operatively coupled to flasher relay 12. In some embodiments, flasher relay 12 can comprise of input voltage terminal 49, ground terminal 31, and switched output terminal 49a. In some embodiments, flasher relay 12 can comprise of potentiometer 25 for controlling the flash frequency of flasher relay 12. In some embodiments, flasher relay 12 can comprise a three-terminal solid state relay device, such as an electronic LED flasher relay, that can be sourced from numerous electronic manufacturers, and readily available from on-line retailers. In some embodiments, vehicle wiring connector 14 can comprise of positive voltage terminal 13, ground terminal 11, left signal terminal 16, right signal terminal 17, and running light terminal 19. In some embodiments, positive voltage terminal 14 of connector 13 can be operatively coupled to terminal 49 of flasher relay 12 via wire conductor 26. In some embodiments, ground terminal 11 of connector 14 can be operatively coupled to terminal 31 of flasher relay 12 via wire conductor 27. In some embodiments, left and right signal terminals 16 and 17 of connector 14 can be operatively coupled to terminal 49 of flasher relay 12 via wire conductor 15.

Referring to FIG. 7, one embodiment of TOWS 20 is shown. In some embodiments, TOWS 20 can comprise TOWS 10 as shown in FIG. 6 in addition to single-pole single-throw (“SPST”) switch 18 operatively coupling wire conductor 15 to wire conductor 37 that can be operatively coupled to running light terminal 19 disposed on connector 14. In this embodiment, running lights on a trailer operatively coupled to running light terminal 19 can also flash in sync with the trailer's left and right signal lights when switch 18 is closed.

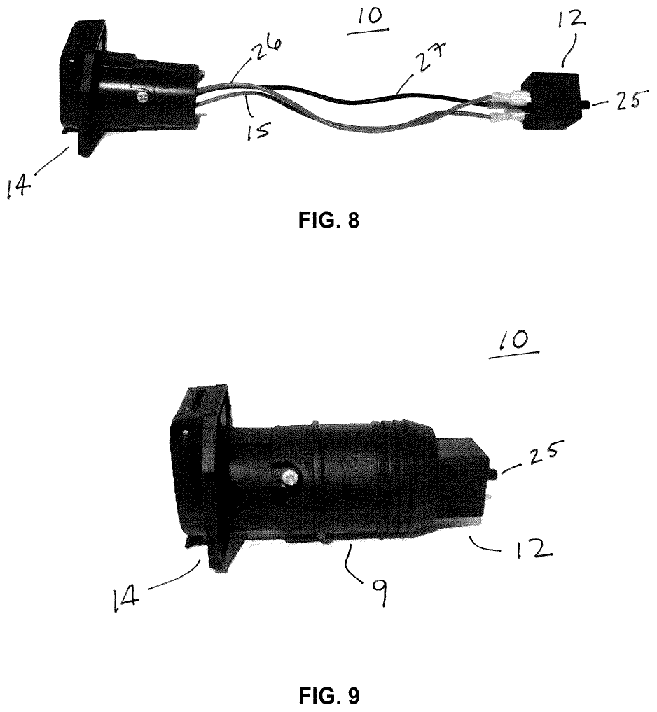

Referring to FIGS. 8 and 9, an example of how TOWS 10 can be assembled is shown. In some embodiments, vehicle wiring connector 14 can be operatively coupled to flasher relay 12 with wire conductors 15, 26, and 27, with the wire conductors and the flasher relay covered with portion 9 of prior art polyethylene pipe coupler E sliding over the end of a housing of vehicle wiring connector 14, thereby enclosing the wire conductors and securing flasher relay 12 therein.

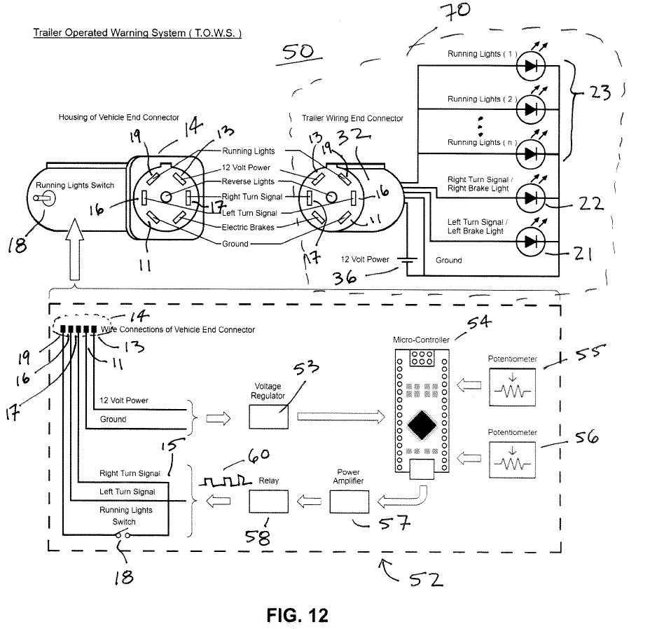

In some embodiments, TOWS 10 or TOWS 20 can be inserted into a 7-way trailer wiring connector 32 disposed on a trailer, as representatively shown in FIG. 12 wherein connector 32 can be operatively connected to a source of +12 volt or +24 volt direct current (“DC”) power in the form of battery 36 disposed on the trailer. When TOWS 10 or TOWS 20 is inserted into trailer wiring connector 32, DC power from battery 36 can operate flasher relay 12 thus causing left and right signal lights disposed on the trailer to flash so as to provide a visual alert to motorists passing by the trailer. If switch 18 is closed on TOWS 20, the running lights disposed on the trailer can also flash in sync with the left and right signal lights. By adjusting potentiometer 25 on flasher relay 12, the rate of the flashing of the lights on the trailer can be increased or decreased to a predetermined flashing frequency.

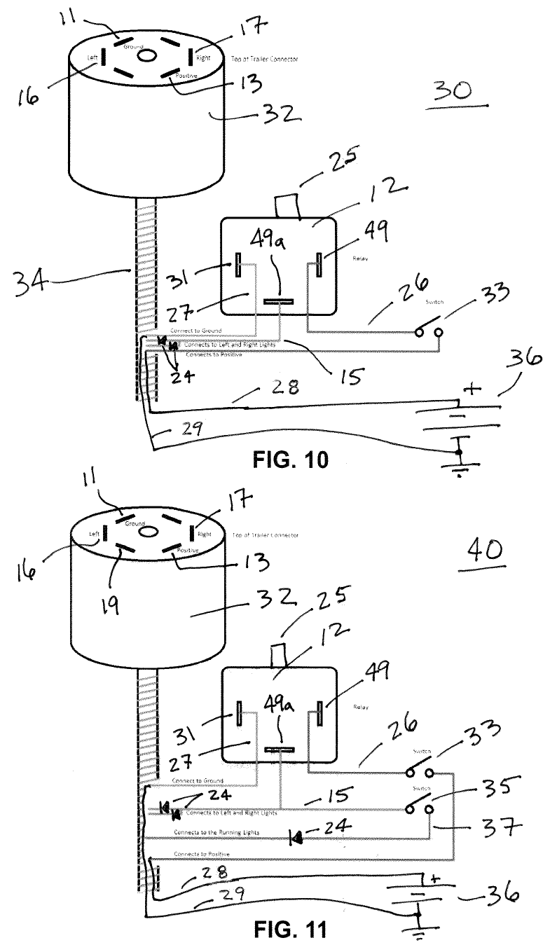

Referring to FIG. 10, an embodiment of TOWS 30 is shown. In this embodiment, the flashing circuit of TOWS 10 can be implemented in the wiring of the trailer. In some embodiments, wire bundle 34 extending from trailer wiring connector 32 can be connected to trailer battery via conductors 28 and 29, wherein input voltage terminal 49 of flasher relay 12 can be coupled to power conductor 28 via wire conductor 26. In some embodiments, DC power can be turned on and off with switch 33 disposed in line with wire conductor 26. In some embodiments, ground terminal 31 of flasher relay 12 can be coupled to ground terminal 11 of connector 32 and ground conductor 29 from battery 36 via wire conductor 27. In some embodiments, switched output terminal 49a of flasher relay 12 can be coupled to left signal terminal 16 and to right signal terminal 17 via wire conductor 15. In this embodiment, TOWS 30 can flash the left and right signal lights by simply closing switch 33. In some embodiments, adjusting potentiometer 25 on flasher relay 12 can adjust the rate of the flashing of the lights on the trailer, which can be increased or decreased to a predetermined flashing frequency.

Referring to FIG. 11, an embodiment of TOWS 40 is shown. In this embodiment, the flashing circuit of TOWS 20 can be implemented in the wiring of the trailer. TOWS 40 can comprise TOWS 30 as shown in FIG. 10 in addition to single-pole single-throw (“SPST”) switch 35 operatively coupling wire conductor 15 to wire conductor 37 that can be operatively coupled to running light terminal 19 disposed on connector 32. In this embodiment, running lights on a trailer operatively coupled to running light terminal 19 can also flash in sync with the trailer's left and right signal lights when switch 35 is closed.

In some embodiments, either of TOWS 30 and TOWS 40 can further comprise isolating diodes 24 disposed in series with each of the wire conductors supplying the left turn signal, the right turn signal, and the running light signal. Isolating diodes 24 allow flasher relay 12 to flash left and right turn signals connected to wire terminals 16 and 17, and to illuminate running lights connected to wire terminal 19, when trailer 70 is parked and there is a need to alert passing motorists, and to allow normal function of the left and right turn signals, and the running lights, when trailer 70 is being towed by a tow vehicle wherein vehicle wiring connector 14 of the tow vehicle is coupled to trailer wiring connector 32 of trailer 70. Without isolating diodes 24, the tow vehicle operating either of a left- or right-turn signal would inadvertently operate both of the left and right turn signals of trailer 70, as well as the running lights if switch 18 is closed

Referring to FIG. 12, an embodiment of TOWS 50 is shown. In some embodiments, TOWS 50 can be similar in configuration to that of TOWS 10 shown in FIG. 6, or that of TOWS 20 as shown in FIG. 7, except for substituting flasher relay 12 with microcontroller circuit 52, which can operate similar in function to flasher relay 12 in addition to providing further features and functions. In some embodiments, TOWS 50 can comprise of vehicle wiring connector 14 further comprising microcontroller circuit 52 disposed therein. In some embodiments, vehicle wiring connector 14 can be coupled to trailer wiring connector 32 disposed on trailer 70, which can further comprise left turn signal 21, right turn signal 22, and running lights 23 all disposed thereon and operatively coupled to their respective wire terminal in trailer wiring connector 32. Battery 36 disposed on trailer 70 can also provide DC power (either +12 volts or +24 volts as well known to those skilled in the art of trailers and the trucking industry) to the respective terminals on trailer wiring connector 32. When vehicle wiring connector 14 is coupled with trailer wiring connector 32, DC power from battery 36 can supply DC power to microcontroller circuit 52 disposed within vehicle wiring connector 14.

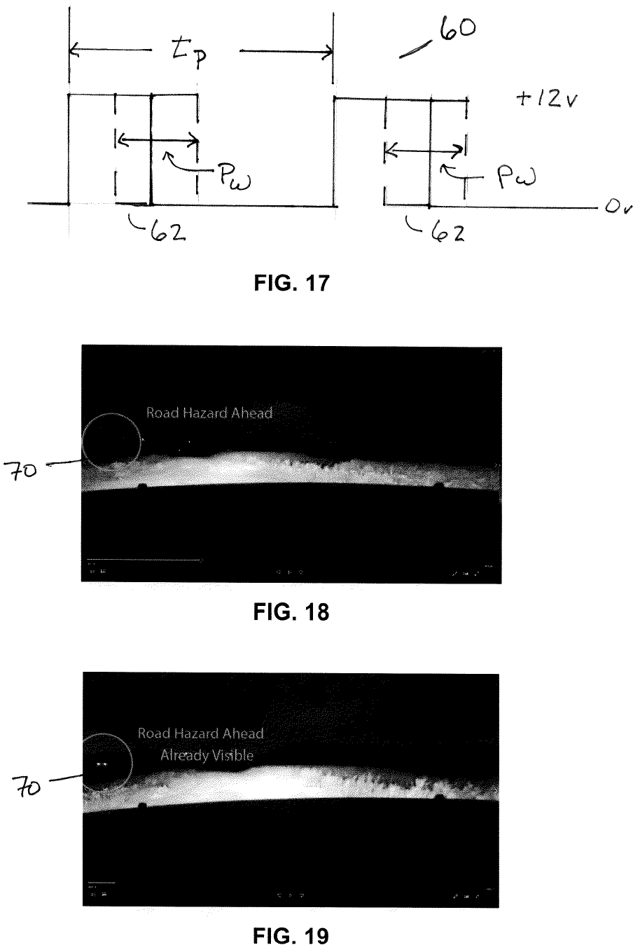

In some embodiments, microcontroller circuit 52 can comprise of voltage regulator 53 operatively coupled to DC power supplied from battery 36 through trailer wiring connector 32 and vehicle wiring connector 14 to regulate the voltage of the DC power to a specified voltage for powering microcontroller 54. In some embodiments, microcontroller 54 can comprise a memory disposed thereon and configured for storing a series of machine-readable instructions that can be carried out by microcontroller 54. In some embodiments, microcontroller circuit 52 can comprise potentiometers 55 and 56 operatively coupled to microcontroller 54. In some embodiments, microcontroller 54 can be operatively coupled to power amplifier 57, which can be configured to operate relay 58 to produce pulse train electrical signal 60 over wire conductors 15 to terminal connections 16 and 17 on vehicle wiring connector 14 to cause left and right turn signals 21 and 22 on trailer 70 to flash on and off. In some embodiments, microcontroller circuit 52 can comprise switch 18 for coupling pulse train electrical signal 60, when switch 18 is closed, to terminal connection 19 on vehicle wiring connector 14 to cause running lights 23 on trailer 70 to flash on and off. In some embodiments, potentiometer 55 can be configured to provide an input setting to microcontroller 54 that, when read by microcontroller 54, can be used to set the time between pulses in pulse train electrical signal 60, denoted as Tp in FIG. 17. In some embodiments, potentiometer 56 can be configured to provide an input setting to microcontroller 54 that, when read by microcontroller 54, can be used to set the width of each pulse in pulse train electrical signal 60, denoted as Pw in FIG. 17. By being able to control Tp, the time between pulses in pulse train electrical signal 60, a frequency can be selected for the rate at which left and right turn signals 21 and 22, and running lights 23, to flash on and off, preferably, at a frequency that will catch the attention of passing motorists. By being able to control Pw, the width of each pulse of pulse train electrical signal 60, the duty cycle of pulse train electrical signal 60 can be lowered to reduce the overall power consumed from battery 36 to flash left and right turn signals 21 and 22, and running lights 23, on and off thereby extending the time that battery 36 can provide sufficient DC power therefor.

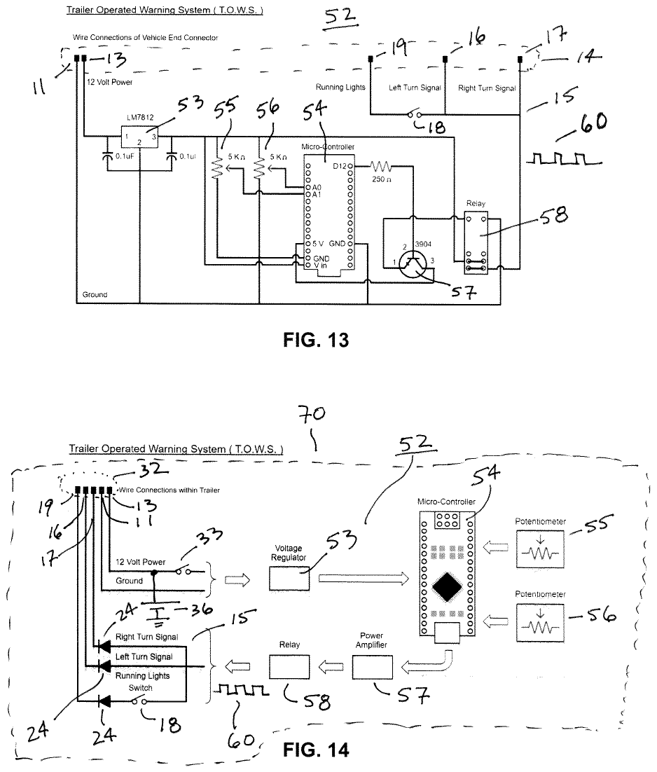

Referring to FIG. 13, an embodiment of an electrical schematic of microcontroller circuit 52 is shown. In some embodiments, voltage regulator 53 can comprise an LM7812 regulator, as well known to those skilled in the art, to regulate the DC power from battery 36 to +12 volts DC for supplying DC power to microcontroller 54, which can comprise an Arduino Nano microcontroller, as well known to those skilled in the art. In some embodiments, potentiometers 55 and 56 can comprise 5 kilo-ohm potentiometers operatively coupled to input data pins disposed on microcontroller 54 wherein potentiometers 55 and 56 can each be adjustable to send preset voltage to microcontroller 54 as a means for setting Tp and Pw of pulse train electrical signal 60. In some embodiments, relay 58 can comprise of a +5 volt DC, double-pole double-throw relay as well known to those skilled in the art. In some embodiments, power amplifier 57 can comprise an NPN transistor, such as a 2N3904 transistor as well known to those skilled in the art, operatively coupling relay 58 to microcontroller 54 as a means for operating relay 58 on and off to produce pulse train electrical signal 60.

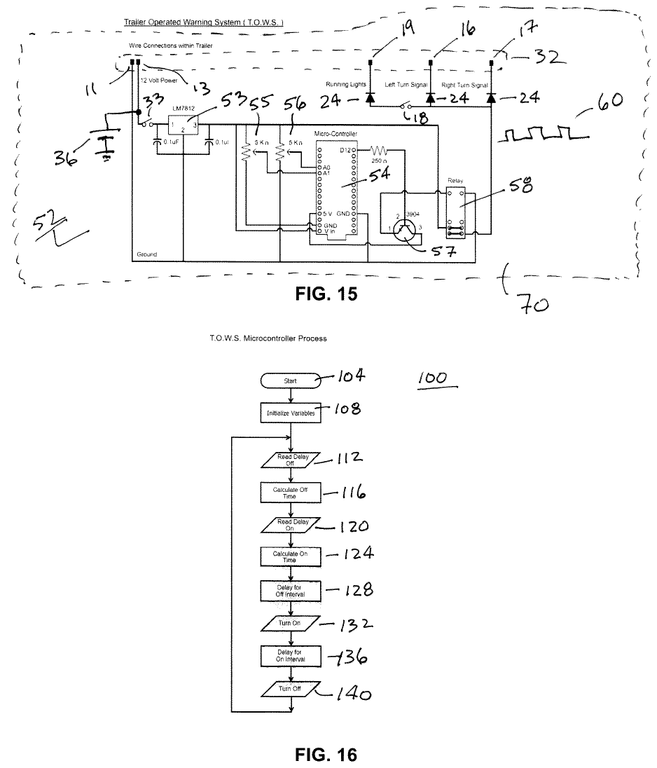

Referring to FIGS. 14 and 15, embodiments of microcontroller circuit 52 are shown that similar in function to TOWS 30 shown in FIG. 10, and to TOWS 40 shown in FIG. 11. In the embodiments shown in FIGS. 14 and 15, flasher relay 12 is substituted with microcontroller circuit 52, as discussed above. In these embodiments, microcontroller circuit 52 can be operatively coupled to terminals 11, 13, 16, 17, and 19 disposed in trailer wiring connector 32, as opposed to vehicle wiring connector 14 as discussed above. In some embodiments, microcontroller circuit 52 can further comprise isolating diodes 24 disposed in series with each of the left turn signal, the right turn signal, and the running light signal. Isolating diodes 24 allow microcontroller circuit 52 to flash left and right turn signals 21 and 22, and running lights 23, when trailer 70 is parked and there is a need to alert passing motorists, and to allow normal function of left and right turn signals 21 and 22, and running lights 23, when trailer 70 is being towed by a tow vehicle wherein vehicle wiring connector 14 of the tow vehicle is coupled to trailer wiring connector 32 of trailer 70. Without isolating diodes 24, the tow vehicle operating either of a left- or right-turn signal would inadvertently operate both of the left and right turn signals 21 and 22 of trailer 70, as well as running lights 23 if switch 18 is closed.

Referring to FIG. 16, one embodiment of flowchart 100 is shown, which can represent the steps that can be embodied in machine-readable instructions stored on the memory disposed on microcontroller 54 and carried out by microcontroller 54 to effect the flashing of left and right signal lights 21 and 22, and running lights 23, on and off. When microcontroller circuit 52 is powered up, represented by step 104, it will then run its initialization routines at step 108. At step 112, microcontroller 54 can read the setting of potentiometer 55 so as to calculate Tp of pulse train electrical signal 60 accordingly at step 116. At step 120, microcontroller 54 can read the setting of potentiometer 56 so as to calculate Pw of pulse train electrical signal 60 accordingly at steps 124 and 128. A step 132, microcontroller 54 can operate relay 58 to start pulse train electrical signal 60. At step 136, microcontroller 54 can wait a period of time corresponding to Pw and then turn off pulse train electrical signal 60 at step 140. Microcontroller 54 can then repeat the foregoing steps starting at step 112 until such time microcontroller circuit 52 is turned off.

In some embodiments, microcontroller 54 can be programmed to flash left and right turn signals 21 and 22, and running lights 23, on and off in any predetermined pattern. In some embodiments, microcontroller 54 can be programmed to flash left and right turn signals 21 and 22, and running lights 23, on and off in Morse Code, as an example, such as Morse Code for a “S-O-S” signal by causing left and right turn signals 21 and 22, and running lights 23, to flash in three short bursts, followed by three long bursts, and then followed by three short bursts, to alert passing motorists of an emergency or help required scenario. In other embodiments, microcontroller 54 can be programmed to flash left and right turn signals 21 and 22, and running lights 23, on and off in any predetermined sequence, frequency, and/or duty cycle.

Referring to FIG. 18 is an example of trailer 70 without having a trailer-operated warning system installed thereon, which results in trailer 70 being nearly invisible to passing motorists in night-time driving conditions whereas, as shown in FIG. 19, trailer 70 having a trailer-operated warning system installed thereon provides a visual indicator to alert passing motorists of the presence of trailer 70.

The various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the embodiments described herein.

Embodiments implemented in computer software can be implemented in software, firmware, middleware, microcode, hardware description languages, or any combination thereof. A code segment or machine-executable instructions can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted via any suitable means including memory sharing, message passing, token passing, network transmission, etc.

The actual software code or specialized control hardware used to implement these systems and methods is not limiting of the embodiments described herein. Thus, the operation and behavior of the systems and methods were described without reference to the specific software code being understood that software and control hardware can be designed to implement the systems and methods based on the description herein.

When implemented in software, the functions can be stored as one or more instructions or code on a non-transitory computer-readable or processor-readable storage medium. The steps of a method or algorithm disclosed herein can be embodied in a processor-executable software module, which can reside on a computer-readable or processor-readable storage medium. A non-transitory computer-readable or processor-readable media includes both computer storage media and tangible storage media that facilitate transfer of a computer program from one place to another. A non-transitory processor-readable storage media can be any available media that can be accessed by a computer. By way of example, and not limitation, such non-transitory processor-readable media can comprise RAM, ROM, EEPROM, CD-ROM or other optical disk storage, magnetic disk storage or other magnetic storage devices, or any other tangible storage medium that can be used to store desired program code in the form of instructions or data structures and that can be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm can reside as one or any combination or set of codes and/or instructions on a non-transitory processor-readable medium and/or computer-readable medium, which can be incorporated into a computer program product.

Although a few embodiments have been shown and described herein, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

We claim:

1. A warning system for a trailer, the trailer comprising a direct current (“DC”) battery disposed thereon, the trailer further comprising a trailer wiring connector disposed thereon, the trailer wiring connector operatively coupled to electrical lights disposed on the trailer, the system comprising:
a) a flasher mechanism operatively coupled to the DC battery and to the electrical lights via the trailer wiring connector, the flasher mechanism configured to flash the electrical lights on and off when operatively coupled to the DC battery; and
b) the flasher mechanism configured for adjusting a frequency of flashing the electrical lights on and off at a predetermined rate.

2. The warning system as set forth in claim 1, wherein the flasher mechanism comprises a three-terminal solid state flasher relay device.

3. The warning system as set forth in claim 2, wherein the flasher relay comprises a first potentiometer configured for adjusting the frequency of flashing the electrical lights on and off.

4. The warning system as set forth in claim 3, wherein the flasher relay comprises a second potentiometer configured for adjusting a duty cycle of flashing the electrical lights on and off.

5. The warning system as set forth in claim 1, further comprising the flasher mechanism disposed in a vehicle wiring connector, the vehicle wiring connector configured for operatively coupling the flasher mechanism to the DC battery and to the electrical lights when the vehicle wiring connector is operatively connected to the trailer wiring connector, whereupon inserting the vehicle wiring connector into the trailer wiring connector results in the flasher mechanism flashing the electrical lights disposed on the trailer on and off.

6. The warning system as set forth in claim 1, wherein the flasher mechanism comprises a microcontroller circuit comprising a microcontroller configured for carrying out a series of machine-readable instructions stored in a memory thereon.

7. The warning system as set forth in claim 6, wherein the microcontroller circuit comprises a first potentiometer operatively coupled to the microcontroller, the combination of the first potentiometer and the microcontroller configured for adjusting the frequency of flashing the electrical lights on and off.

8. The warning system as set forth in claim 7, further comprising a second potentiometer operatively coupled to the microcontroller, the combination of the second potentiometer and the microcontroller configured for adjusting a duty cycle of flashing the electrical lights on and off.

9. The warning system as set forth in claim 1, wherein the electrical lights comprises one or more of left signal lights, right signal lights, brake lights, reverse lights, and running lights.

10. The warning system as set forth in claim 1, further comprising a switch configured for enabling or disabling flashing of the running lights on and off.

11. An improved trailer, the trailer comprising a direct current (“DC”) battery disposed thereon, the trailer further comprising a trailer wiring connector disposed thereon, the trailer wiring connector operatively coupled to electrical lights disposed on the trailer, the improvement comprising a warning system for the trailer, the improvement comprising:
a) a flasher mechanism operatively coupled to the DC battery and to the electrical lights via the trailer wiring connector, the flasher mechanism configured to flash the electrical lights on and off when operatively coupled to the DC battery; and
b) the flasher mechanism configured for adjusting a frequency of flashing the electrical lights on and off at a predetermined rate.

12. The improved trailer as set forth in claim 11, wherein the flasher mechanism comprises a three-terminal solid state flasher relay device.

13. The improved trailer as set forth in claim 12, wherein the flasher relay comprises a first potentiometer configured for adjusting the frequency of flashing the electrical lights on and off.

14. The improved trailer as set forth in claim 13, wherein the flasher relay comprises a second potentiometer configured for adjusting a duty cycle of flashing the electrical lights on and off.

15. The improved trailer as set forth in claim 11, wherein the flasher mechanism comprises a microcontroller circuit comprising a microcontroller configured for carrying out a series of machine-readable instructions stored in a memory thereon.

16. The improved trailer as set forth in claim 15, wherein the microcontroller circuit comprises a first potentiometer operatively coupled to the microcontroller, the combination of the first potentiometer and the microcontroller configured for adjusting the frequency of flashing the electrical lights on and off.

17. The improved trailer as set forth in claim 16, further comprising a second potentiometer operatively coupled to the microcontroller, the combination of the second potentiometer and the microcontroller configured for adjusting a duty cycle of flashing the electrical lights on and off.

18. The improved trailer as set forth in claim 11, wherein the electrical lights comprises one or more of left signal lights, right signal lights, brake lights, reverse lights, and running lights.

19. A method for flashing electrical lights disposed on a trailer, the trailer comprising a direct current (“DC”) battery disposed thereon, the trailer further comprising a trailer wiring connector disposed thereon, the trailer wiring connector operatively coupled to the electrical lights disposed on the trailer, the method comprising the steps of:
a) flashing the electrical lights on and off with a flasher mechanism, the flasher mechanism operatively coupled to the DC battery and to the electrical lights via the trailer wiring connector, the flasher mechanism configured to flash the electrical lights on and off when operatively coupled to the DC battery; and
b) adjusting a frequency of the flashing the electrical lights on and off at a predetermined rate.

20. The method as set forth in claim 19, further comprising adjusting a duty cycle of the flashing the electrical lights on and off.
